(19) United States
(12) Patent Application Publication
(10) Pub. No.: US 2025/0299859 A1
(43) Pub. Date: Sep. 25, 2025

(54) ELECTRONIC COMPONENT

(71) Applicant: Murata Manufacturing Co., Ltd., Kyoto-fu (JP)

(72) Inventors: Kaito SUZUKI, Nagaokakyo-shi (JP); Kenta KONDO, Nagaokakyo-shi (JP)

(73) Assignee: Murata Manufacturing Co., Ltd., Kyoto-fu (JP)

(21) Appl. No.: 19/081,745

(22) Filed: Mar. 17, 2025

(30) Foreign Application Priority Data
Mar. 21, 2024 (JP) 2024-045346

(51) Int. Cl. H01F 5/04; H01F 37/00

(52) U.S. Cl. CPC H01F 5/04; H01F 37/00

(57) ABSTRACT

An electronic component includes an element body, a first base electrode, and a first metal layer. An outer surface of the first base electrode includes a flat surface and a recess dented from the flat surface. The first metal layer fills the recess, and an outer surface of the first metal layer is flat. A melting point of the outermost layer that is in the most outer side portion of the first metal layer is 240° C. or less.

### CROSS-REFERENCE TO RELATED APPLICATION

This application claims benefit of priority to Japanese Patent Application No. 2024-045346, filed Mar. 21, 2024, the entire content of which is incorporated herein by reference.

### BACKGROUND

### Technical Field

The present disclosure relates to an electronic component.

### Background Art

The electronic component disclosed in Japanese Unexamined Patent Application Publication No. 2020-141079 includes an element body and an outer electrode. The material of the element body is ceramic. The outer electrode covers an outer surface of the element body. The outer electrode has a recess. The recess is a portion dented toward the element body relative to the other portion of the outer electrode. When the electronic component is mounted on a substrate or the like, the outer electrode and the substrate or the like are bonded to each other with solder.

### SUMMARY

In the electronic component described in Japanese Unexamined Patent Application Publication No. 2020-141079, when the electronic component is mounted on a substrate or the like, there may be a case that solder does not spread into a space of a recess of an outer electrode and an air bubble remains in the recess. When the air bubble remains after the solder solidifies, the air bubble may cause the outer electrode to be peeled off from the substrate.

Accordingly, the present disclosure provides an electronic component including an element body, a base electrode covering at least part of an outer surface of the element body, and a metal layer covering an outer surface of the base electrode. The outer surface of the base electrode has a flat surface and a recess dented from the flat surface, the metal layer fills the recess and an outer surface of the metal layer is flat. A melting point of an outermost layer that is in the most outer side portion of the metal layer is 240° C. or less.

This makes it less likely that air remains between the outer surface of the metal layer and the substrate or the like.

### BRIEF DESCRIPTION OF THE DRAWINGS

FIG. 1 is a perspective view of an electronic component according to a first embodiment;

FIG. 2 is a perspective view illustrating an internal structure of the electronic component according to the first embodiment;

FIG. 3 is a side view of the electronic component according to the first embodiment;

FIG. 4 is an enlarged sectional view of an outer electrode according to the first embodiment;

FIG. 5 is a perspective view of an electronic component according to a second embodiment; and

FIG. 6 is an enlarged sectional view of an outer electrode in a modification.

### DETAILED DESCRIPTION

Hereinafter, a first embodiment and a second embodiment of the electronic component will be described. Note that the drawings are schematic views to facilitate understanding, and constituents may be enlarged or omitted. Accordingly, a dimensional ratio of the constituents may be different from the actual one.

### First Embodiment of Electronic Component

### Overall Configuration

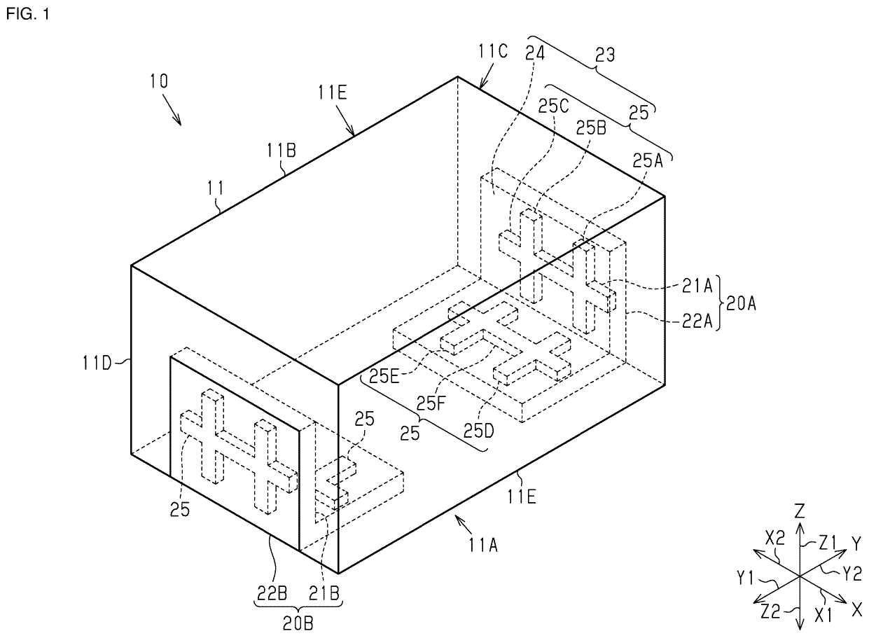

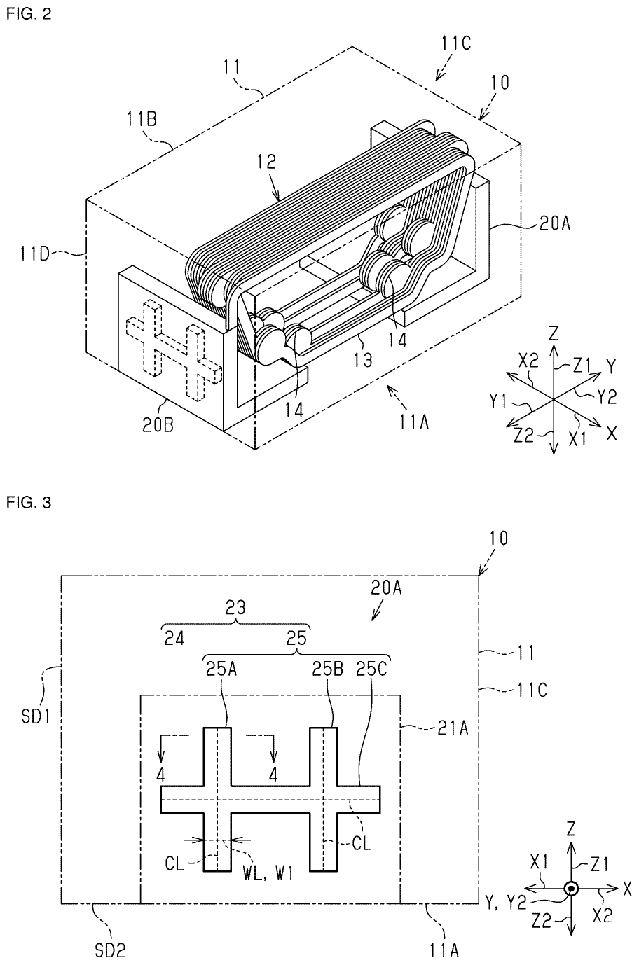

As illustrated in FIG. 1, an electronic component 10 includes an element body 11. As illustrated in FIG. 2, the electronic component 10 includes an inductor wiring 12 as a portion of the element body 11. That is, the electronic component 10 of the first embodiment is a multilayer inductor component.

Although not illustrated in the drawing, the element body 11 has a structure in which a plurality of plate-shaped layers are laminated as a whole. These layers each have a substantially rectangular shape in plan view. As illustrated in FIG. 1, the element body 11 has a substantially rectangular parallelepiped shape. Accordingly, an outer edge shape of each of outer surfaces of the element body 11 has a rectangular shape in plan view. Among the outer surfaces, a surface facing a specific direction is defined as a mounting surface 11A. A surface parallel to the mounting surface 11A is defined as a top surface 11B. A specific surface among outer surfaces perpendicular to the mounting surface 11A is defined as a first end surface 11C. A surface parallel to the first end surface 11C is defined as a second end surface 11D. Each of two outer surfaces perpendicular to both the mounting surface 11A and the first end surface 11C is defined as a side surface 11E.

In the following description, a first axis X is defined as an axis which extends along a lamination direction of the plurality of layers, that is, an axis perpendicular to the side surface 11E. A second axis Y is defined as an axis perpendicular to the first end surface 11C. Further, a third axis Z is defined as an axis perpendicular to the mounting surface 11A. One of directions extending along the first axis X is defined as a first positive direction X1, and a direction opposite to the first positive direction X1 is defined as a first negative direction X2. One of directions extending along the second axis Y in which the first end surface 11C faces is defined as a second negative direction Y2, and a direction opposite to the second negative direction Y2 is defined as a second positive direction Y1. Further, one of directions extending along the third axis Z in which the top surface 11B faces is defined as a third positive direction Z1, and a direction opposite to the third positive direction Z1 is defined as a third negative direction Z2.

Each layer constituting the element body 11 is made of one or more selected from a nonmagnetic insulator such as glass, synthetic resin, or alumina, and a conductor such as copper or silver. The conductors included in the layers above are coupled to each other. Thus, the inductor wiring 12 extending inside the element body 11 is configured as a portion of the element body 11. The portion of the element body 11 excluding the inductor wiring 12 is an insulator.

As illustrated in FIG. 2, the inductor wiring 12 includes a plurality of wiring portions 13 and a plurality of vias 14.

The plurality of wiring portions 13 each extend in a spiral shape when viewed facing the first negative direction X2. The plurality of vias 14 are positioned between the two different wiring portions 13. The via 14 couples one end of the wiring portion 13 and one end of the next wiring portion 13 adjacent to the wiring portion 13 on a first negative direction X2 side. Accordingly, the inductor wiring 12 configured of the plurality of wiring portions 13 and the plurality of vias 14 extends in a spiral shape around an axis parallel to the first axis X as a whole. A far end of the wiring portion 13 in a first positive direction X1 side and a far end of the wiring portion 13 in the first negative direction X2 side are electrically coupled to each other with the plurality of vias 14 interposed therebetween.

As illustrated in FIG. 1, the electronic component 10 includes a first outer electrode 20A and a second outer electrode 20B.

The first outer electrode 20A covers at least part of an outer surface of the element body 11. Specifically, the first outer electrode 20A covers part of the mounting surface 11A and part of the first end surface 11C of the element body 11. Accordingly, the first outer electrode 20A has an L-shape when viewed facing the first positive direction X1. The first outer electrode 20A has a rectangular shape when viewed facing the second positive direction Y1. The first outer electrode 20A has a rectangular shape when viewed facing the third positive direction Z1. The first outer electrode 20A is coupled to a far end of the wiring portion 13 positioned in the first negative direction X2 side, at an end of the first outer electrode 20A in a third positive direction Z1 side.

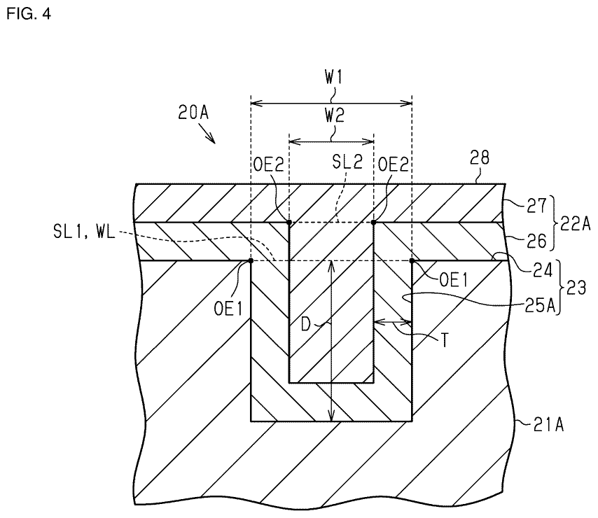

As illustrated in FIG. 4, the first outer electrode 20A includes a first base electrode 21A and a first metal layer 22A. In the first outer electrode 20A, the first base electrode 21A is positioned closest to the element body 11. That is, the first base electrode 21A covers at least part of the outer surface of the element body 11. The first base electrode 21A contains silver as a main component. The term “main component” as used herein means that the proportion of the component in the whole is more than 50%. The first metal layer 22A covers an outer surface 23 of the first base electrode 21A. The first metal layer 22A is a plated layer formed by so-called metal plating, which will be described later in detail. Note that, in FIG. 1 and FIG. 3, a boundary line between the first base electrode 21A and the first metal layer 22A is not illustrated.

As illustrated in FIG. 1, the second outer electrode 20B covers at least part of the outer surface of the element body 11. Specifically, the second outer electrode 20B covers part of the mounting surface 11A and part of the second end surface 11D of the element body 11. The second outer electrode 20B has an L-shape when viewed facing the first negative direction X2. The second outer electrode 20B has a rectangular shape when viewed facing the second negative direction Y2. The second outer electrode 20B has a rectangular shape when viewed facing the third positive direction Z1. An end of the second outer electrode 20B in a second positive direction Y1 side does not reach the first outer electrode 20A. The second outer electrode 20B is coupled to a far end of the wiring portion 13 positioned in the first positive direction X1 side, at an end of the second outer electrode 20B in the third positive direction Z1 side. Accordingly, the first outer electrode 20A and the second outer electrode 20B are electrically coupled to each other via the inductor wiring 12. Although a boundary between the second outer electrode 20B and the wiring portion 13 is indicated with a solid line in FIG. 3, the boundary may be unclear in an actual case. For example, the second outer electrode 20B and the wiring portion 13 may be integrally molded.

The second outer electrode 20B includes a second base electrode 21B and a second metal layer 22B. In the second outer electrode 20B, the second base electrode 21B is positioned closest to the element body 11. That is, the second base electrode 21B covers at least part of the outer surface of the element body 11. The second base electrode 21B contains silver as a main component. Specifically, the material of the second base electrode 21B is the same as the material of the first base electrode 21A. The second metal layer 22B covers an outer surface of the second base electrode 21B. The structure of the second metal layer 22B is the same as that of the first metal layer 22A. That is, the second metal layer 22B is a plated layer formed by metal plating. Note that, in FIG. 1 and FIG. 3, a boundary line between the second base electrode 21B and the second metal layer 22B is not illustrated.

### Details of Outer Electrode

Hereinafter, a detailed configuration of the first outer electrode 20A will be described. The configuration of the second outer electrode 20B is the same as the configuration of the first outer electrode 20A, and thus a description thereof will be omitted.

As illustrated in FIG. 1, an outer surface 23 of the first base electrode 21A includes a flat surface 24 and a plurality of recesses 25. The flat surface 24 is a surface that protrudes most relative to the outer surface of the element body 11. The recess 25 is a portion dented from the flat surface 24.

The plurality of recesses 25 include a first recess 25A to a sixth recess 25F. Among the above, the first recess 25A to the third recess 25C are positioned in a portion of the first base electrode 21A covering the first end surface 11C.

As illustrated in FIG. 3, the first recess 25A has a rectangular shape elongated in a direction extending along the third axis Z when the first base electrode 21A is viewed in plan view facing the second positive direction Y1. In other words, the first recess 25A is a groove-shaped dent. Here, in a perspective view facing a direction orthogonal to the first end surface 11C, a side of the first end surface 11C on the first negative direction X2 side is referred to as a first side SD1. A center line CL of the first recess 25A extends along the first side SD1. A length of the center line CL of the first recess 25A is five times or more the maximum value of a width W1 of the first recess 25A. The width W1 of the first recess 25A is substantially constant over the entire first recess 25A. The width W1 is 4 μm or more and 26 μm or less (i.e., from 4 μm to 26 μm).

Note that the width W1 of the recess 25 is a measurement of a width line WL when the width line WL is the shortest line segment among line segments coupling any point on a first outer edge of the recess 25 and a point on a second outer edge on an opposite side of the first outer edge in a perspective view from a direction orthogonal to the flat surface 24. A center line CL of the recess 25 is a line segment drawn by tracing a plurality of midpoints of the width line WL. Note that, in another recess 25, which is a portion intersecting with the third recess 25C described later, the first recess 25A does not have a clear outer edge. The width line WL, therefore, is not drawn in a portion like the above. In FIG. 3, the center line CL and the width line WL each are virtually illustrated by a dot-dash line. In FIG. 3, the outer edges of the element body 11 and the first base electrode 21A each are indicated by a dashed-and-double dotted line.

When the first base electrode 21A is viewed in plan view facing the second positive direction Y1, the first recess 25A is positioned in the first positive direction X1 side relative to a center of the first base electrode 21A. The first recess 25A is positioned at the center of the first base electrode 21A in a direction extending along the third axis Z. In a perspective view facing the direction orthogonal to the flat surface 24 of the first base electrode 21A, an outer edge of the first recess 25A does not intersect with an outer edge of the first base electrode 21A. In other words, the first recess 25A does not reach the outer edge of the first base electrode 21A.

As illustrated in FIG. 4, in a sectional view through a section orthogonal to the flat surface 24, the first recess 25A is dented from the flat surface 24 in a rectangular shape. A depth D of the first recess 25A is substantially constant as a whole. The depth D is 2 μm or more and 15 μm or less (i.e., from 2 μm to 15 μm). Specifically, in the sectional view, there is drawn a tangent line in contact with both the flat surfaces 24 positioned on both sides of the recess 25. At this time, two points positioned on a center side of the recess 25, among points at which the tangent line and the outer surface 23 of the first base electrode 21A are in contact with each other, are defined as two first opening ends OE1. A first line segment SL1, which couples the two first opening ends OE1 of the first recess 25A, is assumed. The depth D is the maximum measurement from the first line segment SL1 to a surface of the first recess 25A in a direction orthogonal to the first line segment SL1.

As illustrated in FIG. 3, a shape of the second recess 25B is the same as the shape of the first recess 25A. That is, a center line CL of the second recess 25B extends along the first side SD1. In other words, the center line CL of the second recess 25B is substantially parallel to the center line CL of the first recess 25A. A width W1 of the second recess 25B is substantially constant as a whole. The width W1 of the second recess 25B is the same as the width W1 of the first recess 25A and is 4 μm or more and 26 μm or less (i.e., from 4 μm to 26 μm). A depth D of the second recess 25B is substantially constant as a whole. The depth D of the second recess 25B is the same as the depth D of the first recess 25A and is 2 μm or more and 15 μm or less (i.e., from 2 μm to 15 μm).

When viewed facing the second positive direction Y1, the second recess 25B is positioned in the first negative direction X2 side relative to the center of the first base electrode 21A. A position of the second recess 25B in the direction extending along the third axis Z is aligned with a position of the first recess 25A. In the perspective view facing the direction orthogonal to the flat surface 24 of the first base electrode 21A, an outer edge of the second recess 25B does not intersect with the outer edge of the first base electrode 21A.

The third recess 25C has a rectangular shape elongated in a direction extending along the first axis X when the first base electrode 21A is viewed in plan view facing the second positive direction Y1. Here, in a perspective view facing the direction orthogonal to the first end surface 11C, a side orthogonal to the first side SD1 and positioned on a third negative direction Z2 side of the first end surface 11C is defined as a second side SD2. In the case above, a center line CL of the third recess 25C extends along the second side SD2. In other words, the center line CL of the third recess 25C is substantially perpendicular to the center line CL of the first recess 25A and the center line CL of the second recess 25B. A length of the center line CL of the third recess 25C is five times or more the maximum value of a width W1 of the third recess 25C.

The third recess 25C is positioned at substantially the center of the first base electrode 21A in the direction extending along the third axis Z when the first base electrode 21A is viewed in plan view facing the second positive direction Y1. The third recess 25C intersects with the first recess 25A and the second recess 25B at a center of each recess 25 in a longitudinal direction. In addition, in the perspective view facing the direction orthogonal to the flat surface 24 of the first base electrode 21A, an outer edge of the third recess 25C does not intersect with the outer edge of the first base electrode 21A.

The width W1 of the third recess 25C is substantially constant as a whole. The width W1 of the third recess 25C is the same as the width W1 of the first recess 25A and is 4 μm or more and 26 μm or less (i.e., from 4 μm to 26 μm). A depth D of the third recess 25C is substantially constant as a whole. The depth D of the third recess 25C is the same as the depth D of the first recess 25A and is 2 μm or more and 15 μm or less (i.e., from 2 μm to 15 μm).

As illustrated in FIG. 4, the first metal layer 22A entirely fills the recess 25 of the outer surface 23 of the first base electrode 21A. An outer surface 28 of the first metal layer 22A is flat. In more detail, the first metal layer 22A has a first layer 26 and a second layer 27.

The first layer 26 covers the outer surface 23 of the first base electrode 21A. The first layer 26 contains one or more of nickel (Ni) and gold (Au) as a main component. The main component of the first layer 26 in the first embodiment is nickel. A melting point of the first layer 26, therefore, is 400° C. or higher.

An outer surface of the first layer 26 follows the outer surface 23 of the first base electrode 21A to some extent. That is, an outer surface of a portion of the first layer 26 covering the flat surface 24 is flat reflecting a shape of the flat surface 24. An outer surface of a portion of the first layer 26 covering the recess 25 is dented from the outer surface of the portion of the first layer 26 covering the flat surface 24. A width W2 of the dent of the first layer 26 is 6.0 times or less a thickness T of the first layer 26. In the first embodiment, the width W2 of the dent is approximately two times the thickness T of the first layer 26. The thickness T of the first layer 26 is smaller than the depth D of the recess 25 of the first base electrode 21A.

A method of calculating the width W2 of the dent is the same as the method of calculating the width W1 of the recess 25 in the first base electrode 21A. That is, the width W2 of the dent is the shortest distance between two points on an outer edge of the dent of the first layer 26 in the perspective view from the direction orthogonal to the flat surface 24. The thickness T of the first layer 26 is the shortest distance from any point on the outer surface of the first layer 26 to the first base electrode 21A in a section orthogonal to the flat surface 24 of the first base electrode 21A and orthogonal to the center line CL of the recess 25.

The second layer 27 covers the outer surface of the first layer 26. In other words, the second layer 27 is the outermost layer that is in the most outer side portion of the first metal layer 22A. The second layer 27 contains tin (Sn) as a main component. A melting point of the second layer 27, therefore, is 240° C. or less. Accordingly, the melting point of the second layer 27 is lower than the melting point of the first layer 26.

The second layer 27 fills the dented portion of the first layer 26. In addition, substantially the entire outer surface 28 of the second layer 27 is flat. The outer surface 28 of the second layer 27 being “flat” means that the outer surface 28 of a portion of the second layer 27 filling the dent of the first layer 26 is positioned on an opposite side of the first base electrode 21A relative to an opening surface of the dent. Specifically, first, the first base electrode 21A is viewed in a section through a section orthogonal to the flat surface 24. A second line segment SL2, which couples two second opening ends OE2 of the dent of the first layer 26, is assumed. In the case above, the second layer 27 is flat when the entire outer surface 28 of the portion of the second layer 27 filling the first layer 26 does not intersect with the second line segment SL2. The “flat surface” refers to an outer surface that is flat as described above. Note that a method of determining the second opening end OE2 is the same as the method of determining the first opening end OE1. In FIG. 4, the second line segment SL2 is virtually indicated by a dot-dash line.

As illustrated in FIG. 1, the fourth recess 25D to the sixth recess 25F of the plurality of recesses 25 of the first base electrode 21A each are positioned in a portion of the first base electrode 21A covering the mounting surface 11A.

A shape of each of the fourth recess 25D and the fifth recess 25E is the same as a shape of each of the first recess 25A and the second recess 25B. A positional relationship of each of the fourth recess 25D and the fifth recess 25E on a surface of the first base electrode 21A facing the third negative direction Z2 is the same as a positional relationship of each of the first recess 25A and the second recess 25B on the surface of the first base electrode 21A facing the second negative direction Y2. A shape of the sixth recess 25F is the same as the shape of the third recess 25C. A positional relationship of the sixth recess 25F on the surface of the first base electrode 21A facing the third negative direction Z2 is the same as a positional relationship of the third recess 25C on the surface of the first base electrode 21A facing the second negative direction Y2. A relationship of the first layer 26 and the second layer 27 relative to the fourth recess 25D to the sixth recess 25F is the same as a relationship of the first layer 26 and the second layer 27 relative to the first recess 25A to the third recess 25C. That is, the first metal layer 22A fills the fourth recess 25D to the sixth recess 25F, and the outer surface 28 of the first metal layer 22A in a portion filling the recess 25 is flat.

The plurality of recesses 25 may be formed by cutting the first base electrode 21A with a laser or the like after the first base electrode 21A is formed in a known process of manufacturing the electronic component 10. The first metal layer 22A may be formed by plating the outer surface 23 of the first base electrode 21A.

### Effects of First Embodiment

Note that, regarding effects common to the first base electrode 21A and the second base electrode 21B, the first base electrode 21A will be described as a representative example, and a description of the effects of the second base electrode 21B will be omitted.
(1-1) In the first embodiment, the first metal layer 22A fills the recess 25 of the outer surface 23 of the first base electrode 21A. Consequently, the bonding strength between the first metal layer 22A and the first base electrode 21A may be ensured. On the other hand, since the melting point of the second layer 27 which is the outermost layer of the first metal layer 22A is low, when the electronic component 10 is mounted on a substrate or the like, the second layer 27 is melted and easily integrated with solder or the like. Accordingly, the bonding strength of the first metal layer 22A and the solder or the like may also be ensured. The outer surface 28 of the first metal layer 22A is flat. Consequently, air is less likely to enter between the outer surface 28 of the first metal layer 22A and a substrate or the like when the electronic component 10 is mounted. Accordingly, air is unlikely to remain in the recess 25, and this makes it possible to prevent remaining air from affecting the bonding strength between the first outer electrode 20A and a substrate or the like.
(1-2) Since the first base electrode 21A includes the recess 25, as compared with a case that the recess 25 is not included, the bonding strength with a substrate or the like may be ensured even when an outer surface of the first outer electrode 20A has a small surface area. Accordingly, even when a size of the entire first outer electrode 20A is reduced, stray capacitance generated between the first base electrode 21A and the inductor wiring 12 inside the element body 11 may be lowered while ensuring the bonding strength with a substrate or the like.
(1-3) In the first embodiment, the first metal layer 22A has a two-layer structure. The first layer 26 dents substantially along a shape of the recess 25 of the first base electrode 21A. The outer surface 28 of the second layer 27, which is the outermost layer, is flat. The melting point of the second layer 27 is lower than the melting point of the first layer 26. Since the first layer 26 has a dent on the surface, an anchor effect easily occurs when the second layer 27 is bonded to a substrate or the like by solder. That is, the bonding strength is likely to be high.
(1-4) In the first embodiment, the main component of the first base electrode 21A is silver. The main component of the first layer 26 includes one or more of nickel and gold. The main component of the second layer 27 is tin. By being formed of the materials above, an electric resistance value of the first outer electrode 20A may be lowered while maintaining the strength and the like required as the first outer electrode 20A.
(1-5) In the first embodiment, the width W2 of a dent in the outer surface of the first layer 26 is equal to or greater than 1.0 times and equal to or less than 6.0 times (i.e., from 1.0 times to 6.0 times) the thickness T of the first layer 26. With the width W2 being equal to or more than the thickness T, an anchor effect is likely to occur when the first outer electrode 20A and a substrate or the like are bonded. In addition, since the width W2 is equal to or less than 6.0 times the thickness T, the outer surface 28 of a portion of the second layer 27 filling a dent of the first layer 26 is likely to be flat when the first outer electrode 20A is formed.
(1-6) In the first embodiment, a length of the center line CL of the recess 25 is five times or more the maximum value of the width W1 of the recess 25. In other words, the recess 25 has a groove shape. When the electronic component 10 is bonded to a substrate or the like, so-called self-alignment occurs to the first outer electrode 20A until solder solidifies. That is, the electronic component 10 is aligned to some extent by surface tension of the melted solder. A portion of the second layer 27 filling the recess 25 has a larger volume than the other portion, thereby having the large surface tension. Consequently, when the recess 25 has a groove shape, a center axis of the electronic component 10 tends to be aligned with a direction extending along the center line CL of the recess 25.
(1-7) In the first embodiment, the recess 25 has a groove shape extending along a side of a rectangular outer surface. That is, in a portion of the first outer electrode 20A covering the first end surface 11C, the center line CL of the recess 25 extends along the first side SD1 and the second side SD2 of the first end surface 11C. Since the recess 25 extends along the side of the rectangular outer surface, the center axis of the electronic component 10 tends to be aligned to face a direction extending along the side of the rectangular outer surface.
(1-8) In the first embodiment, the outer edge of the recess 25 does not intersect with the outer edge of the first base electrode 21A. In other words, the recess 25 does not reach the outer edge of the first base electrode 21A. If the recess 25 reaches the outer edge of the first base electrode 21A, a crack may occur in the first base electrode 21A with the reached place being a starting point. Accordingly, with the use of the present configuration, the occurrence of such a crack may be suppressed.
(1-9) In the first embodiment, the recess 25 is dented in a rectangular shape in a sectional view through a section orthogonal to the flat surface 24. This increases a contact area between a surface of the recess 25 and the first metal layer 22A, and thus increases the bonding strength between the first base electrode 21A and a substrate or the like when the electronic component 10 is mounted on the substrate or the like.
(1-10) In the first embodiment, the depth D of the recess 25 is 2 μm or more and 15 μm or less (i.e., from 2 μm to 15 μm). The width W1 of the recess 25 is 4 μm to 26 μm. Being within the numerical range above, occurrence of an air bubble between the outer surface 28 of the first metal layer 22A and a substrate or the like may more remarkably be suppressed. Thus, the bonding strength may be increased.

### Second Embodiment of Electronic Component

Next, a second embodiment of the electronic component will be described. The electronic component 10 according to the second embodiment is different from the electronic component 10 according to the first embodiment in the shape of the element body 11 and the shape of each outer electrode. In the following description, the same configurations of an electronic component 100 according to the second embodiment as those of the first embodiment are denoted by the same reference signs, and a description thereof will be omitted. Also in the second embodiment, a configuration of a second outer electrode 200B is the same as a configuration of a first outer electrode 200A. A description of the second outer electrode 200B, therefore, is omitted.

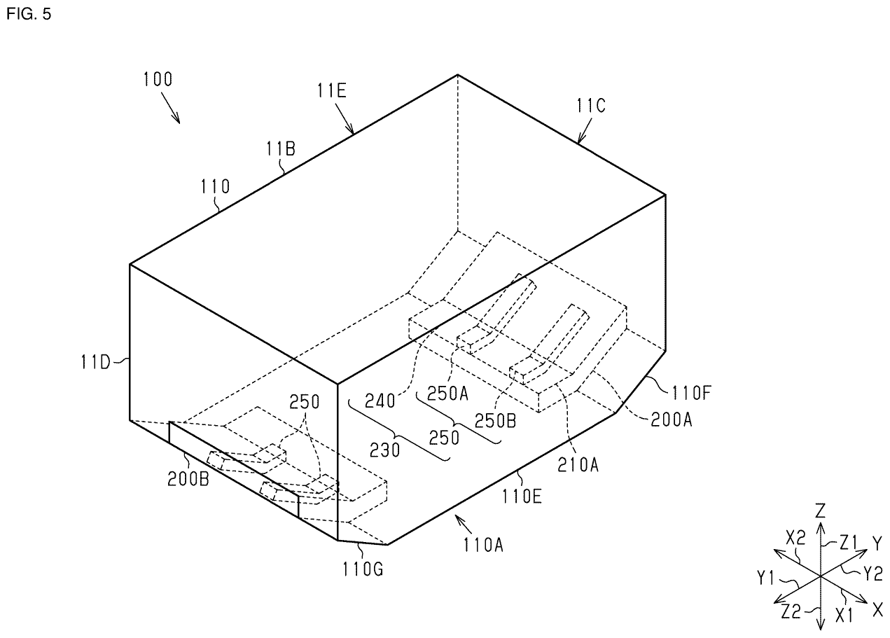

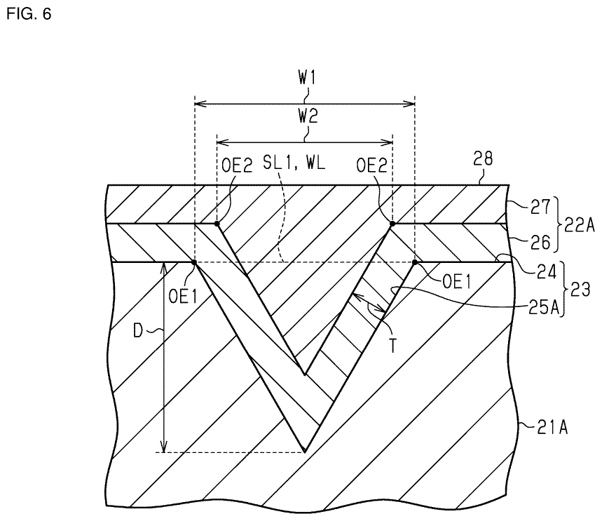

As illustrated in FIG. 5, an element body 110 in the second embodiment has a shape in which two boundaries of the element body 11 in the first embodiment, having a rectangular parallelepiped shape, each are chamfered. One boundary is that between the mounting surface 11A and the first end surface 11C, and the other boundary is that between the mounting surface 11A and the second end surface 11D. Each side surface 110E of the element body 110, therefore, has a hexagonal shape.

Specifically, the element body 110 has a first mounting surface 110A, a second mounting surface 110F, and a third mounting surface 110G. Each surface has a rectangular flat surface.

The first mounting surface 110A is a far end outer surface of the element body 110 in the third negative direction Z2 side. The first mounting surface 110A is a surface parallel to the top surface 11B.

The second mounting surface 110F is adjacent to the first mounting surface 110A and the first end surface 11C. In other words, the second mounting surface 110F couples the first mounting surface 110A and the first end surface 11C. An angle on an inner side of the element body 11 among angles formed by the second mounting surface 110F and the first mounting surface 110A is 105 degrees or more and 165 degrees or less (i.e., from 105 to 165 degrees). An angle formed by the second mounting surface 110F and the first end surface 11C is 105 degrees or more and 165 degrees or less (i.e., from 105 to 165 degrees). In the present embodiment, each angle is approximately 135 degrees.

The third mounting surface 110G is adjacent to the first mounting surface 110A and the second end surface 11D. In other words, the third mounting surface 110G couples the first mounting surface 110A and the second end surface 11D. An angle on an inner side of the element body 11 among angles formed by the third mounting surface 110G and the first mounting surface 110A is 105 degrees or more and 165 degrees or less (i.e., from 105 to 165 degrees). An angle formed by the third mounting surface 110G and the second end surface 11D is 105 degrees or more and 165 degrees or less (i.e., from 105 to 165 degrees). In the present embodiment, each angle is approximately 135 degrees.

In the second embodiment, the first outer electrode 200A covers at least part of each of part of the first mounting surface 110A and the second mounting surface 110F. That is, the first outer electrode 200A has a plate shape bent along the first mounting surface 110A and the second mounting surface 110F.

In the first outer electrode 200A, an outer surface 230 of a first base electrode 210A has a flat surface 240 and a plurality of recesses 250. The plurality of recesses 250 include a seventh recess 250A and an eighth recess 250B.

The seventh recess 250A has a substantially linear groove shape in a perspective view facing the third negative direction Z2. That is, a center line CL of the seventh recess 250A extends along the second axis Y. The seventh recess 250A is positioned in the first negative direction X2 side relative to a center of the first base electrode 210A in the perspective view facing the third negative direction Z2. An outer edge of the seventh recess 250A does not intersect with an outer edge of the first base electrode 210A. The seventh recess 250A continuously extends from a portion of the first base electrode 210A covering the first mounting surface 110A to a portion of the first base electrode 210A covering the second mounting surface 110F.

The eighth recess 250B has a substantially linear groove shape in the perspective view facing the third negative direction Z2. That is, a center line CL of the eighth recess 250B extends along the second axis Y. The eighth recess 250B is positioned in the first positive direction X1 side relative to the center of the first base electrode 210A in the perspective view facing the third negative direction Z2. The outer edge of the seventh recess 250A does not intersect with the outer edge of the first base electrode 210A. In addition, the eighth recess 250B does not intersect with the seventh recess 250A. The eighth recess 250B continuously extends from a portion of the first base electrode 210A covering the first mounting surface 110A to a portion of the first base electrode 210A covering the second mounting surface 110F.

In the second embodiment, the configuration of the first metal layer 22A is the same as that of the first embodiment. Accordingly, the first metal layer 22A fills the seventh recess 250A and the eighth recess 250B, and an outer surface of the first metal layer 22A is flat. A melting point of the outermost layer that is in the most outer side portion of the first metal layer 22A is 240° C. or less.

### Effects of Second Embodiment

According to the second embodiment, the following effects are obtained in addition to the above (1-1) to (1-10).
(2-1) In the second embodiment, an angle on an inner side of the element body 11 among angles formed by the second mounting surface 110F and the first mounting surface 110A is 105 degrees or more and 165 degrees or less (i.e., from 105 to 165 degrees). Because the angle is approximately 135±30 degrees, even when an air bubble is generated between the first mounting surface 110A and solder at the time of bonding the electronic component 100 to a substrate or the like with the solder, the air bubble is likely to be discharged along the second mounting surface 110F inclined against the first mounting surface 110A. Accordingly, the bonding strength is less likely to lower.
(2-2) In the second embodiment, the seventh recess 250A and the eighth recess 250B each are positioned in a portion of the first base electrode 210A covering the first mounting surface 110A. The first outer electrode 200A in the second embodiment has a smaller surface area than the L-shaped electrode such as the first outer electrode 20A in the first embodiment, and thus stray capacitance tends to lower. As in the above-described configuration, since the recess 250 is positioned at least on the first mounting surface 110A, bonding strength with a substrate or the like is unlikely to lower when the electronic component 100 is mounted, even in a case that the surface area of the first outer electrode 200A is small.

### Modifications

The above-described embodiments may be modified as follows. The first embodiment, the second embodiment, and the following modifications can be implemented in combination with each other within a range not technically inconsistent. Hereinafter, the modifications of the first outer electrode 20A are the same as those of the second outer electrode 20B.

The electronic component 10 is not limited to an inductor component. For example, a multilayer ceramic capacitor may be used. Accordingly, the electronic component 10 does not necessarily include the inductor wiring 12. The electronic component 10 does not necessarily have a multilayer structure.

The shape of the element body 11 is not limited to the example of the embodiment. A boundary of the outer surface of the element body 11 may be subjected to so-called R-chamfering. Even when a corner of the element body 11 is R-chamfered, the element body 11 has a rectangular outer surface as long as the element body 11 has a substantially rectangular shape in plan view. The element body 11 does not necessarily have a rectangular outer surface.

In the above-described embodiment, when the element body 11 and the outer electrodes are viewed as a whole, the outer shape of the electronic component 10 is a rectangular parallelepiped shape. However, the shape of the element body 11 itself may have a rectangular parallelepiped shape. Each outer electrode may cover the outer surface of the element body 11 having the rectangular parallelepiped shape.

The configuration of the first outer electrode 20A is not limited to the example of the embodiment. For example, the first metal layer 22A may be a plated layer formed of one layer with the first layer 26 described above being omitted. Even in the case above, it is sufficient that the first metal layer 22A fills the recess 25 of the outer surface 23 of the first base electrode 21A and the outer surface 28 of the first metal layer 22A is flat. The first metal layer 22A may be a plated layer including three or more layers.

In the case that the first metal layer 22A includes the first layer 26 and the second layer 27, the outer surface of the first layer 26 does not necessarily have a dent. That is, the first layer 26 may fill the recess 25 of the first base electrode 21A, and the outer surface of the first layer 26 may be flat. In the case above, the melting point of the first layer 26 as well is preferably 240° C. or less.

A material of the first base electrode 21A, a material of the first layer 26, and a material of the second layer 27 each are not limited to the example of the embodiment. The melting point of the first layer 26 may be lower than the melting point of the second layer 27.

The first metal layer 22A may be formed by other than metal plating. It is acceptable that at least the melting point of the outermost layer of the first metal layer 22A is 240° C. or less.

The number of the recesses 25 on the outer surface 23 of the first base electrode 21A is not restricted. The number of the recesses 25 may be one, or seven or more. It is acceptable that the outer surface 23 of the first base electrode 21A includes the recess 25 and the outer surface of the second base electrode 21B does not include the recess 25. That is, it is acceptable that, as the entire electronic component 10, the outer surface of any of the base electrode includes the recess 25.

The shape of the recess 25 is not limited to the example of the embodiment. The length of the center line CL of the recess 25 may be less than five times the maximum value of the width W1. For example, the shape of the recess 25 may be circular in plan view. The width W1 of the recess 25 may be less than 4 μm or greater than 26 μm. For example, the outer edge of the recess 25 may intersect with the outer edge of the first base electrode 21A.

The depth D of the recess 25 may be less than 2 μm or greater than 15 μm. Even in the case above, the presence of the recess 25 may increase the bonding strength as compared with a case that the recess 25 is not present.

A position of the recess 25 in the first base electrode 21A is not limited to the example of the embodiment. For example, the recess 25 may be positioned only in a portion of the first base electrode 21A covering the mounting surface 11A. Further, in the second embodiment, the recess 250 is not necessarily positioned in a portion of the first base electrode 210A covering the first mounting surface 110A. That is, the recess 250 may be positioned only in a portion of the first base electrode 210A covering the second mounting surface 110F. Even in the case above, when the second mounting surface 110F and a substrate or the like are bonded by solder or the like, bonding strength is unlikely to lower.

The width W2 of the dent in the first layer 26 may be less than 1 times or more than 6.0 times the thickness T of the first layer 26. Even in the case above, at least the effect described in (1-1) may be obtained as long as the second layer 27 fills the dent and the outer surface 28 of the second layer 27 is flat.

The center line CL of the recess 25 does not necessarily extend along the side of the rectangular outer surface. For example, in the first embodiment, the center line CL of the first recess 25A does not necessarily extend along the first side SD1. In the first embodiment, the center line CL of the third recess 25C does not necessarily extend along the second side SD2. For example, the center line CL of the first recess 25A may be inclined to the first side SD1 by 45 degrees.

In a sectional view through a section orthogonal to the flat surface 24, the recess 25 does not necessarily be dented in a rectangular shape. For example, as illustrated in FIG. 6, the recess 25 may be dented in a triangular shape against the flat surface 24 in a sectional view through a section orthogonal to the flat surface 24. In the case above, the outer surface of the portion of the first metal layer 22A filling the recess 25 is more likely to be flat. This may more remarkably suppress the occurrence of an air bubble between the outer surface 28 of the first metal layer 22A and a substrate or the like.

In the second embodiment, an angle on an inner side of the element body 11 among angles formed by the second mounting surface 110F and the first mounting surface 110A may be less than 105 degrees or may be greater than 165 degrees. Regardless of the angle, the presence of the recess 250 may increase the bonding strength to a substrate or the like.

The method for manufacturing the electronic component 10 is not limited to the example of the embodiment. The recess 25 may be formed in the base electrode by any method.

### Supplementary Note

The technical ideas that can be understood from the embodiments and modifications will be described.
[1] An electronic component, comprising an element body; a base electrode covering at least part of an outer surface of the element body; and a metal layer covering an outer surface of the base electrode, wherein the outer surface of the base electrode has a flat surface and a recess dented from the flat surface, the metal layer fills the recess and an outer surface of the metal layer is flat, and a melting point of an outermost layer that is in a most outer side portion of the metal layer is 240° C. or less.
[2] The electronic component according to [1], wherein the metal layer has a first layer and a second layer as the outermost layer covering the first layer, a melting point of the second layer is lower than a melting point of the first layer, an outer surface of a portion of the first layer covering the recess is dented from an outer surface of a portion of the first layer covering the flat surface, and the second layer fills the dented portion of the first layer and an outer surface of the second layer is flat.
[3] The electronic component according to [2], wherein the base electrode contains silver, the first layer contains one or more of nickel and gold, and the second layer contains tin.
[4] The electronic component according to [2] or [3], wherein a width of the dented portion of the first layer is equal to or greater than 1.0 times and equal to or less than 6.0 times (i.e., from 1.0 times to 6.0 times) a thickness of the first layer.
[5] The electronic component according to any one of [1] to [4], wherein a length of a center line of the recess is five times or more a maximum value of a width of the recess which is a measurement in a direction orthogonal to the center line.
[6] The electronic component according to [5], wherein the width is 4 μm or more and 26 μm or less (i.e., from 4 μm to 26 μm).
[7] The electronic component according to any one of [1] to [6], wherein the element body has a rectangular outer surface, the base electrode covers at least part of the rectangular outer surface, and in a perspective view facing a direction orthogonal to the rectangular outer surface, a center line of the recess extends along a side of the rectangular outer surface.
[8] The electronic component according to [7], wherein when a specific side among sides of the rectangular outer surface is defined as a first side and a side extending in a direction intersecting with the first side is defined as a second side, in a perspective view facing the direction orthogonal to the rectangular outer surface, the recess includes a first recess extending along the first side and a second recess extending along the second side.
[9] The electronic component according to any one of [1] to [8], wherein in a perspective view facing a direction orthogonal to the flat surface, an outer edge of the recess does not intersect with an outer edge of the base electrode.
[10] The electronic component according to any one of [1] to [9], wherein in a sectional view through a section orthogonal to the flat surface, the recess is dented from the flat surface in a rectangular shape.
[11] The electronic component according to any one of [1] to [10], wherein in a sectional view through a section orthogonal to the flat surface, the recess is dented from the flat surface in a triangular shape.
[12] The electronic component according to any one of [1] to [11], wherein in a sectional view through a section orthogonal to the flat surface, a line segment coupling opening ends of the recess is assumed and when a maximum measurement from the line segment to a surface of the recess in a direction orthogonal to the line segment is defined as a depth of the recess, the depth is 2 μm or more and 15 μm or less (i.e., from 2 μm to 15 μm).
[13] The electronic component according to any one of [1] to [12], wherein when a specific surface of outer surfaces of the element body is defined as a first mounting surface and the outer surface adjacent to the first mounting surface is defined as a second mounting surface, the base electrode covers at least part of each of the first mounting surface and the second mounting surface, and an angle formed by the first mounting surface and the second mounting surface and positioned on an inner side of the element body is 105 degrees or more and 165 degrees or less (i.e., from 105 degrees to 165 degrees).
[14] The electronic component according to [13], wherein the recess is positioned in a portion of the base electrode covering the first mounting surface.

What is claimed is:

1. An electronic component, comprising:
an element body;
a base electrode covering at least a portion of an outer surface of the element body; and
a metal layer covering an outer surface of the base electrode,
wherein
the outer surface of the base electrode has a flat surface and a recess dented from the flat surface,
the metal layer fills the recess, and an outer surface of the metal layer is flat, and
a melting point of an outermost layer that is in a most outer side portion of the metal layer is 240° C. or less.

2. The electronic component according to claim 1, wherein
the metal layer has a first layer and a second layer as the outermost layer covering the first layer,
a melting point of the second layer is lower than a melting point of the first layer,
an outer surface of a portion of the first layer of the metal layer which covers the recess of the base electrode is dented from an outer surface of a portion of the first layer of the metal layer which covers the flat surface of the base electrode, and
the second layer fills the dented portion of the first layer and an outer surface of the second layer is flat.

3. The electronic component according to claim 2, wherein
the base electrode includes silver,
the first layer includes at least one of nickel and gold, and
the second layer includes tin.

4. The electronic component according to claim 2, wherein
a width of the dented portion of the first layer is from 1.0 times to 6.0 times a thickness of the first layer.

5. The electronic component according to claim 1, wherein
a length of a center line of the recess of the base electrode is equal to or greater than 5 times a maximum value of a width of the recess of the base electrode which is a dimension in a direction orthogonal to the center line.

6. The electronic component according to claim 5, wherein
the width of the recess of the base electrode is from 4 μm to 26 μm.

7. The electronic component according to claim 1, wherein
the element body has a rectangular outer surface,
the base electrode covers at least a portion of the rectangular outer surface, and
in a perspective view when viewed in a direction orthogonal to the rectangular outer surface, a center line of the recess extends along a side of the rectangular outer surface.

8. The electronic component according to claim 7, wherein
when a specific side among sides of the rectangular outer surface is defined as a first side and a side extending in a direction intersecting with the first side is defined as a second side, in a perspective view when viewed in the direction orthogonal to the rectangular outer surface, the recess includes a first recess extending along the first side and a second recess extending along the second side.

9. The electronic component according to claim 1, wherein
in a perspective view when viewed in a direction orthogonal to the flat surface of the base electrode, an outer edge of the recess of the base electrode does not intersect with an outer edge of the base electrode.

10. The electronic component according to claim 1, wherein
in a cross-sectional view through a cross section orthogonal to the flat surface, the recess is dented from the flat surface in a rectangular shape.

11. The electronic component according to claim 1, wherein
in a cross-sectional view through a cross section orthogonal to the flat surface, the recess is dented from the flat surface in a triangular shape.

12. The electronic component according to claim 1, wherein
in a cross-sectional view through a cross section orthogonal to the flat surface, a line segment connecting opening ends of the recess is assumed and when a maximum dimension from the line segment to a surface of the recess in a direction orthogonal to the line segment is defined as a depth of the recess, the depth is from 2 μm to 15 μm.

13. The electronic component according to claim 1, wherein
when a specific surface of outer surfaces of the element body is defined as a first mounting surface and the outer surface adjacent to the first mounting surface is defined as a second mounting surface, the base electrode covers at least a portion of each of the first mounting surface and the second mounting surface, and
an angle defined by the first mounting surface and the second mounting surface and on an inner side of the element body is from 105 degrees to 165 degrees.

14. The electronic component according to claim 13, wherein
the recess of the base electrode is in a portion of the base electrode covering the first mounting surface.
